(19) United States
(12) Patent Application Publication
(10) Pub. No.: US 2009/0021357 A1
(43) Pub. Date: Jan. 22, 2009

(54) Wireless and keyless vehicle entry alarm alert system

(76) Inventor: Alexander Jacobs Evans, Pittsburgh, PA (US)

Correspondence Address: Alexander J. Evans, 7111 Bennington Woods Drive, Pittsburgh, PA, 15237, US

(21) Appl. No.: 11/879,813

(22) Filed: Jul. 19, 2007

(51) Int. Cl. B60R 25/10

(52) U.S. Cl. 340/426.36

(57) ABSTRACT

A wireless keyless entry system can lock, unlock automotive doors, trunks, etc. without the use of an ignition key and can disarm an onboard anti-theft alarm system or in the alterative can trigger the alarm as a deterrent. The novelty of this invention relates to the fact that the owner of the vehicle is unaware of an alarm state triggered at the vehicle if the owner is out of eye sight and or ‘ear shot’ of the vehicle. The new wireless and keyless entry system would include an RF transmitter in the vehicle that would transmit a unique code when the vehicle is in an alarm state. The unique signal would be received by a portable receiver/controller carried by the owner/operator of the vehicle, triggering a visible light; an audible alarm, pulsing or steady; and/or a vibrator alerting the owner to investigate the automotive alarm emanating from the vehicle.

### REFERENCES

U.S. Pat. No. 4,205,325; May 27, 1980

U.S. Pat. No. 4,672,375; Jun. 9, 1987

U.S. Pat. No. 4,719,460; Jan. 12, 1988

U.S. Pat. No. 5,467,080; Nov. 14, 1995

### BACKGROUND OF THE INVENTION

Keyless entry systems have evolved over the years from key pads attached or integrated on an external surface of a vehicle as described in U.S. Pat. No. 4,205,325 that require the owner/operator to ‘key-in’ a preset numeric sequence to gain access to the vehicle without triggering an alarm, to wireless entry systems which accomplish the same purposes by transmitting a RF signal containing a unique code to a receiver-controller in the vehicle. An example of an improvement to the key pad system having a security system is found in U.S. Pat. No. 5,467,080. U.S. Pat. No. 4,672,375 describes wireless and keyless entry system as an improvement over the key pad system. This improvement incorporates the use of a small hand held wireless device, called a “FOB”, to remotely perform keyless entry system functions. Many improvements have been made on this concept including but not limited to the inability of an owner/operator to physically lock a vehicle if the FOB was left in the vehicle (U.S. Pat. No. 4,719,460). Whatever the type of keyless entry, all systems integrate or work sympathetically with the vehicle's theft deterrent alarm system. The alarm system in a vehicle has also gone through much iteration of improvements incorporating many new functions of security such as motion detection and sound monitoring.

All current applications of a wireless and keyless entry system utilize a FOB that only communicates predetermined instructions to a vehicle with a unique code, such as unlocking doors, and does not have the ability to receive feedback from the vehicle's alarm state. Thus if the owner/operator has locked his vehicle and enters a store, restaurant, building, etc. and the car alarm is triggered by motion such as a pet in the locked car; bumped by another vehicle; or by sound waves in the spectrum of the alarm sensors, the owner/operator will be unaware of the alarm condition and thus unable to investigate the alarm which may or may not be a false alarm. Thus the vehicle's alarm will continue sounding and/or flashing creating an annoyance to the surrounding environment and leading to people ignoring the alarm as it sounds/flashes or as it reactivates after a predetermined period of time if the alarm condition remains.

### BRIEF SUMMARY OF THE INVENTION

It is the object of the invention to provide an alert system as part of an automotive wireless and keyless entry system which would notify the owner/operator of a vehicle that the vehicle is in an alarm state. This feature provides the owner/operator an alarm after the owner/operator has moved away from the secured vehicle a sufficient distance that the vehicle's anti-theft alarm(s) could not be seen or heard or otherwise identified that the alarm is from the owner/operator's vehicle. Upon receiving such alarm, the owner/operator can return to the vehicle to investigate the alarm and take corrective action.

In order to accomplish the above-mentioned and other objects, the alert system according to the present invention, comprises a wireless transmitter located in a vehicle which transmits a preset coded signal when the vehicle's anti-theft system is in an alarm state and an alerting system that comprises a miniature wireless receiver/controller that has a noise making device, vibrator, light or any combination thereof in response to the preset coded signal from the above mentioned transmitter in the vehicle. The above mentioned alerting system/device is battery operated and portable by hand or in pockets/pouches.

In the preferred structure, the above mentioned alert system would be integrated into a small hand held wireless device, a FOB. Such FOB is used by the owner/operator to remotely lock or unlock doors, trunks, or other devices all in or on the vehicle and to either trigger the vehicle's alarm in case of a personal emergency or in the alternative to deactivate the anti-theft alarm by clearing the alarm condition (e.g. by unlocking the doors), and a transmitter/encoder circuitry integrated into the anti-theft circuitry of the vehicle, as generally shown in FIG. 2, that transmits a preset coded signal indicating an alarm condition in said vehicle. Such FOBs and anti-theft circuitry are typically supplied by the OEM of the vehicle. The FOB with an integrated alert system could have a selector switch to provide the owner/operator the options of switching the alert function of the FOB on/off, vibrator only; sound only; light only or various combinations thereof. Provisions to re-charge the battery in the FOB could also be provided.

In another preferred structure, the alert system would be incorporated in a stand alone portable device which would be separate from the FOB and the transmitter/encoder device would be a separate device that would be connected to the vehicle's alarm system. This structure would be useful as part of an add-on kit for vehicles at the OE level or especially in the after market.

### BRIEF DESCRIPTION OF THE DRAWINGS

The present invention will be understood more fully with the accompanying drawings and a detailed description of the preferred embodiment of the invention which, however, should not be assumed to limit the invention to the specific embodiment, but are offered for explanation and understanding only.

In the drawings:

FIG. 1 is a logic diagram showing the general concepts of a wireless and keyless entry system including an anti-theft alarm system in a vehicle as it is know in the art;

FIG. 2 is a logic diagram showing the general concepts of FIG. 1 and the integration of the vehicle alarm alert system involving both the circuitry/logic of the FOB and vehicle according to the present invention.

### DETAILED DESCRIPTION OF THE INVENTION

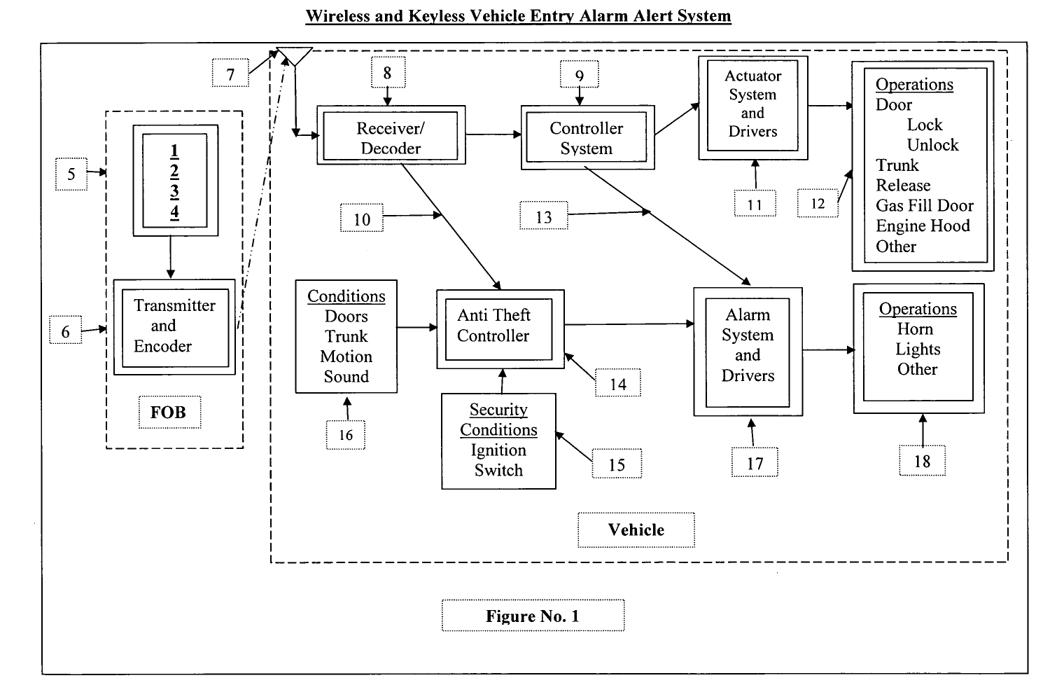

Referring to the drawings, FIG. 1, the wireless and keyless entry system including an anti-theft alarm system generally comprises a FOB with a push button pad 5 and a preset code transmitter 6. The push button pad 5 provides the capability of selecting various functions that the controller system 9, located in the vehicle, would perform, such as door lock 1 and unlock 2, truck release 3 and personal emergency signal 4. The preset code transmitter 6 sends an RF signal to an antenna 7 located in the vehicle. The signal is received by receiver/decoder 8 which validates or ignores the signal and if validated, communicates the desired function from the FOB to the actuator/drivers system 11 and also sends a deactivation signal 10 to the anti-theft controller 14 so that an alarm signal will not be generated when the selected function takes place (e.g. unlock doors). Such validated signal transmitted from the receiver/decoder 8 to the controller system 9 will cause the actuator/drivers system 11 to trigger the appropriate actuator (e.g. unlock doors) or will trigger the alarm(s) 19 directly in case of a personal emergency 4 signal from the FOB. Also included in the logic diagram is the general concept of an anti-theft system, items 14 through 18. The anti-theft controller 14 monitors security conditions 15 and sensor conditions 16 and switches the alarm system 17 state from off to on or on to off depending on the predetermined condition logic and current state of the various inputs from items 15 and 16. An example of this operation is as follows: a predetermined condition for setting the anti-theft controller 14 in a ready/monitor state would be that the ignition key has been removed and all doors and the truck are locked. The anti-theft controller 14 now monitors the sensor conditions 16, and for example if a door or trunk is opened without the use of a key or the FOB, a signal is sent to alarm system 17 which sends alarm signals to the alarm operators 18 triggering a horn and/or lights for example. The alarm state will remain in effect until the alarm condition is removed, for example, by unlocking the doors with a key or FOB.

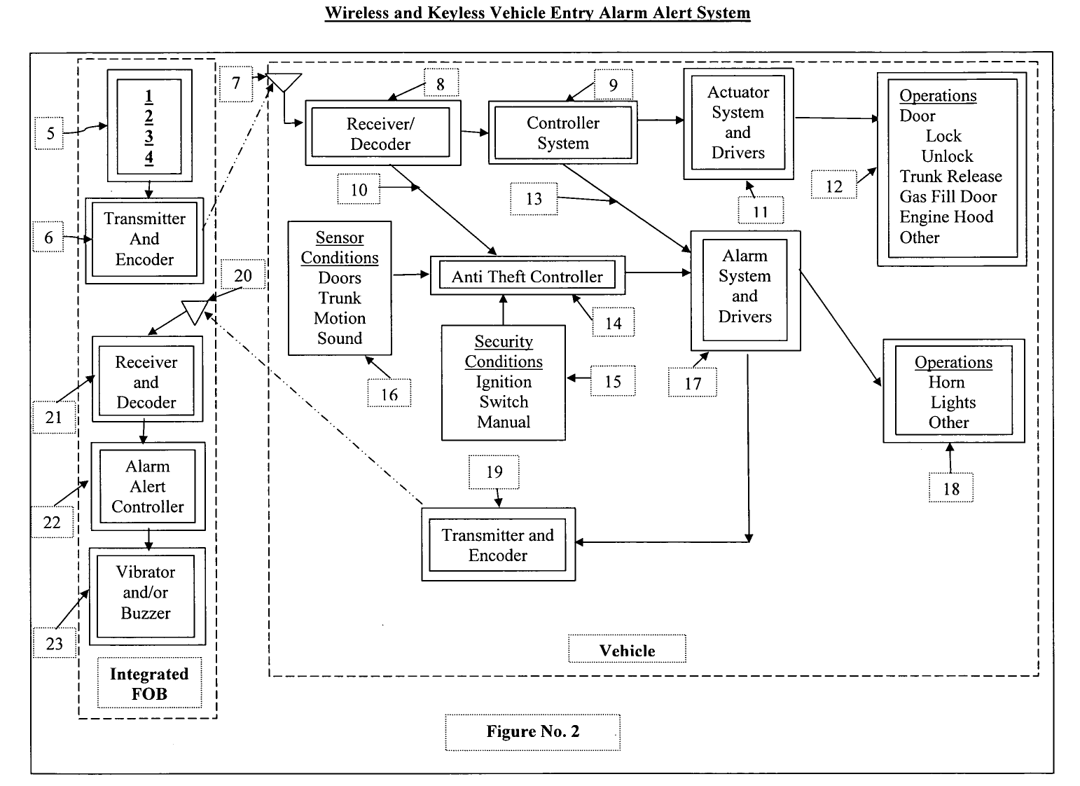

Referring to FIG. 2, the present invention in the preferred embodiment incorporates the integration of the control logic circuitry of the transmitter and encoder controller 19 into the circuitry of FIG. 1 and in particular to the alarm system 17 so that a signal from the alarm system 17, indicating an alarm condition, would also be sent to the transmitter and encoder controller 19. This controller in turn would transmit a RF signal having a preset code to an antenna 20 on or in the Integrated FOB as per the preferred embodiment. The signal is received by a receiver and decoder 21 which validates or ignores the signal. If such signal is validated, the alarm alert controller 22 is activated, and it triggers a selected alert, such as a light, vibrator and/or buzzer 23, which would continue in the alert condition until the vehicle alarm condition is removed/changed or the vibrator and/or buzzer 23 in the Integrated FOB is switched off.

Similarly, the alarm alert function of the present invention could also be accomplished with the transmitter and encoder controller 19 as a separate/stand-alone controller that could be added to a vehicle by connecting it to the circuitry of the alarm system 17. The alert system logic as shown in FIG. 2, items 20 through 23, could be integrated into a separate/stand-alone device(s) which then would be carried separately from the typical automotive FOB, as described in FIG. 1, by the owner/operator and/or other passengers of the vehicle as the case maybe.

Therefore, the present invention fulfills all of the objects and advantages sought thereof.

What is claimed is:

1. An alarm alert system for a vehicle with an anti-theft system for providing a sensory signal to an individual that such vehicle is in an alarm state comprising:
a transmitter and controller outputting an encoded RF signal from a vehicle indicative of an alarm condition from the vehicle's anti-theft system;
an alerting device(s) which has a controller for receiving and comparing such signal to a preset code in such controller and a second controller within such device(s) which would cause the alerting device(s) to emit a sound, light and/or vibration when triggered by such first transmitter and controller.

2. The alarm alert system as set forth in claim 1, wherein said alerting device(s) is portable and the logic and circuitry is integrated into a portable, wireless and keyless vehicle entry receiver/controller.

3. The alarm alert system as set forth in claim 1, wherein said alerting device(s) is portable and the logic and circuitry is contained in a separate device independent of a wireless and keyless vehicle entry receiver/controller.

4. The alarm alert system as set forth in claim 1, wherein said alerting device(s) in claim 2 and claim 3 contains a battery recharging port.

5. The alarm alert system as set forth in claim 1, wherein said alerting device(s) in claim 2 and claim 3 contains a multi position switch which enables the operator to select the functions of on/off, sound, vibration, light or any combination thereof.

6. The transmitter and controller as set forth in claim 1, wherein the transmitter and controller logic and circuitry are integrated in the anti-theft circuitry of the vehicle.

7. The transmitter and controller as set forth in claim 1, wherein the transmitter and controller logic and circuitry is contained in a separate device that can be connected to the anti-theft circuitry of the vehicle.
